(19) United States
(12) Patent Application Publication
(10) Pub. No.: US 2026/0163948 A1
(43) Pub. Date: Jun. 11, 2026

(54) METHOD AND DEVICE FOR PROCESSING DATA ASSOCIATED WITH AT LEAST ONE CONTROLLER OF A MANUFACTURING DEVICE

(71) Applicant: Robert Bosch GmbH, Stuttgart (DE)

(72) Inventors: Henrik Klessig, Renningen (DE); Rene Guillaume, Boeblingen (DE)

(21) Appl. No.: 18/704,094

(22) PCT Filed: Oct. 20, 2022
(86) PCT No.: PCT/EP2022/079160

§ 371 Date: Apr. 24, 2024

(30) Foreign Application Priority Data
Oct. 26, 2021 (DE) 10 2021 212 042.3

(51) Int. Cl. H04L 67/125; G05B 19/418

(52) U.S. Cl. CPC H04L 67/125; G05B 19/4185; G05B 2219/31102

(57) ABSTRACT

A method for processing data associated with at least one controller of a manufacturing device, for example a manufacturing system. The method includes: ascertaining first information characterizing a communication link, for example a capacity of a communication link, between the at least one controller and at least one further device; influencing at least one application executed by means of the at least one controller on the basis of the first information.

### BACKGROUND INFORMATION

The present invention relates to a method, for example a computer-implemented method, for processing data associated with at least one controller of a manufacturing device.

The present invention further relates to a device for processing data associated with at least one controller of a manufacturing device.

### SUMMARY

Exemplary embodiments of the present invention relate to a method for processing data associated with at least one controller of a manufacturing device, for example a manufacturing system, comprising: ascertaining first information characterizing a communication link, for example a capacity of a communication link, between the at least one controller and at least one further device; influencing at least one application executed by means of the at least one controller on the basis of the first information. According to further exemplary embodiments, this makes possible a flexible adaptation of the operation of the application, for example to the capacity of the communication link. In further exemplary embodiments, for example, several controllers or associated applications and/or processes, for example manufacturing processes, can also be influenced on the basis of at least the first information.

In further exemplary embodiments of the present invention, the at least one controller is designed to execute distributed open- and/or closed-loop control applications, in which the at least one controller is, for example, arranged remotely from the at least one further device and exchanges data with the at least one further device via the communication link.

In further exemplary embodiments of the present invention, the at least one further device is a sensor device and/or an actuator device.

In further exemplary embodiments of the present invention, the at least one controller can, for example, control at least one actuator device, for example on the basis of data from at least one sensor device. In other exemplary embodiments, for example, a closed-loop control circuit can thus be provided.

For example, in further exemplary embodiments of the present invention, a plurality of controllers can be provided, for example three controllers in the present case, which for example form a manufacturing device, for example a manufacturing system, or a part of a manufacturing device MD, for example a manufacturing system. For example, each of the controllers is associated with a process, which may, for example, in each case relate to one or more aspects of a manufacturing process.

In further exemplary embodiments of the present invention, the communication link has, for example, a wireless data connection at least in some areas, for example using a radio technology, for example based on a wireless communication system, for example according to the 4G or 5G or another standard.

In further exemplary embodiments of the present invention, combinations of at least one wireless data connection and at least one wired data connection for the communication link are also possible.

In further exemplary embodiments of the present invention, the method further comprises: ascertaining second information characterizing a future capacity, for example an estimated future capacity, of the communication link between the at least one controller and the at least one further device, wherein the ascertainment is performed, for example, on the basis of the first information.

In further exemplary embodiments of the present invention, the influencing of the at least one application executed by means of the at least one controller is carried out at least temporarily on the basis of the first information and/or on the basis of the second information.

In further exemplary embodiments of the present invention, the first information and/or the second information can also be considered as capacity indicator(s) of the communication link and/or of the communication system.

In further exemplary embodiments of the present invention, the method comprises at least one of the following elements: a) ascertaining whether a cycle time, for example a current cycle time and/or a prespecifiable target cycle time, of the application can be maintained and/or can be achieved using the communication link and/or a communication system providing the communication link; b) ascertaining a probability with which a cycle time, for example a current cycle time and/or a prespecifiable target cycle time, of the application can be maintained and/or can be achieved; c) ascertaining a cycle time for the application, which can be achieved, for example with a prespecifiable probability; d) estimating future values relating to at least one of the above aspects a), b), c).

In further exemplary embodiments of the present invention, the cycle time can, for example, characterize a time between two successive messages of the same type, which, for example, the controller exchanges with the at least one further device, for example a sensor device and/or an actuator device.

In further exemplary embodiments of the present invention, the first information and/or the second information comprises at least one of the following elements: a) a latency, for example an end-to-end latency, for example according to 3GPP (3rd Generation Partnership Project) TS (technical specification) 22.104; b) a utilization of resources, for example radio resources, of a base station associated with the communication link and/or of a radio cell and/or another component of a communication system; c) a transmission duration, for example according to 3GPP TS 22.104; d) channel state information, for example of a radio channel associated with the communication link, for example channel state information, CSI; e) a receive power of a reference signal, for example reference signal receive power, RSRP; f) signal-to-interference-plus-noise ratio, SINR.

In further exemplary embodiments of the present invention, the influencing comprises changing a or the cycle time of the application, wherein, for example, the changing is performed on the basis of a prespecifiable precision and/or duration of a process associated with the application, for example a closed-loop control process.

In further exemplary embodiments of the present invention, the method comprises at least one of the following elements: a) initializing, for example, the at least one controller and/or the application; b) starting or executing the application; c) monitoring the communication link and/or a or the communication system, wherein, for example, the first information and/or the second information are obtained during the monitoring; d) evaluating data obtained, for example, during the monitoring; e) ascertaining, for example on the basis of the evaluation, whether the influencing of the application is to be carried out; f) optionally carrying out the influencing of the application.

In further exemplary embodiments of the present invention, the initialization comprises, for example, at least one of the following elements: a) setting target values, for example for the application or a controller executing the application; b) specifying requirements and/or constraints; c) configuring, for example, the communication link or at least one component of a communication system associated with the communication link.

In further exemplary embodiments of the present invention, starting the application comprises: starting the application with initial parameter values, for example based on the initialization.

In further exemplary embodiments of the present invention, the monitoring of the communication link and/or the communication system comprises, for example, at least one of the following elements: a) repeated, for example regular, monitoring of the communication link and/or of the communication system; b) at least temporary storage of information relating to the monitoring, for example of the first information.

In further exemplary embodiments of the present invention, the evaluation of the data, for example obtained during monitoring, comprises at least one of the following elements: a) evaluating the data, for example according to prespecifiable criteria; b) ascertaining, for example estimating, future values relating to the data, for example future trends.

In further exemplary embodiments of the present invention, determining whether the influencing of the application is to be carried out comprises: a) comparing current values, for example values associated with the application, for example values of the control system, with estimated values relating to the communication link or the communication system; b) ascertaining whether values of the control system are to be changed or influenced.

In further exemplary embodiments of the present invention, the method comprises: repeating at least one of the following elements: c) monitoring the communication link and/or a or the communication system, wherein, for example, the first information and/or the second information are obtained during the monitoring; d) evaluating data, for example obtained during the monitoring; e) ascertaining, for example on the basis of the evaluation, whether the influencing of the application is to be carried out; f) optionally carrying out the influencing of the application.

In further exemplary embodiments of the present invention, a plurality of processes are associated with the manufacturing device, wherein, for example, the plurality of processes can be executed sequentially, wherein the method comprises:
ascertaining a process of the plurality of processes whose process cycle time cannot be reduced (for example cannot be reduced without falling below a required precision);
influencing, for example increasing, a process duration of at least one other process of the plurality of processes.

In further exemplary embodiments of the present invention, the influencing, for example increasing, of the process duration of the at least one other process of the plurality of processes is carried out taking into account at least one of the following aspects: a) the process cycle time is not extended and/or does not exceed a prespecifiable threshold value (thereby ensuring, for example, that increasing an individual process duration does not have any negative influence on manufacturing throughput); b) individual process durations do not exceed a maximum process cycle time; c) an individual process duration of the at least one other process of the plurality of processes corresponds to at least one prespecification for the at least one other process (for example, in order to take into account process-specific boundary conditions, for example relating to process duration and/or speed and/or precision).

In further exemplary embodiments of the present invention, a manufacturing device, for example a production line or manufacturing line, can comprise a number of machines and/or manufacturing cells by means of which, for example, various manufacturing processes can be applied to workpieces. In further exemplary embodiments, the manufacturing processes may include at least one of the following elements: assembly, soldering, gluing, etc.

In further exemplary embodiments of the present invention, workpieces generally pass through the production line in a prespecifiable sequence of processes, for example manufacturing processes, and with an identical process cycle time, which is to be distinguished, for example, from a cycle time of, for example, a controller or of a control loop that can be realized, for example, by means of the controller. In further exemplary embodiments of the present invention, the cycle time of, for example, the controller or of the control loop lies, for example, within the range of a few milliseconds while the process cycle time lies, for example, within the range of seconds. For example, the cycle time, for example of the controller or of the control loop, characterizes a compromise or trade-off between a process duration and a precision of the process, whereas the process cycle time indicates for how long a process or the relevant process is applied to a workpiece.

In further exemplary embodiments of the present invention, transfers of a workpiece from one process to another process are carried out, for example, for all workpieces in at least substantially the same time, i.e. independently of the relevant process. However, in further exemplary embodiments, the actual process time spent may vary among different processes of a production line, wherein, for example, one of the different processes of the production line may be regarded as a bottleneck for the total production time (for example, sum of the respective process durations plus, if applicable, the time required for transferring the workpieces between the processes), for example the process with the longest process cycle time.

In further exemplary embodiments of the present invention, for example, production engineers can ascertain the longest process cycle time or the (bottleneck) process with the longest process cycle time and, for example, reduce the longest process cycle time, for example in order to maximize production throughput (for example, characterizable by a number of workpieces, for example products, produced per unit of time).

In further exemplary embodiments of the present invention in which, for example, at least one wireless communication link, for example based on a 5G infrastructure, is used for communication between different processes, wherein, for example, the different processes use the same (shared) transmission medium (for example, air or radio interface), it may be advantageous according to further exemplary embodiments to jointly configure or influence the processes, for example also the communication processes via the wireless communication link, of a manufacturing device comprising several processes or controllers, for example a production line. In further exemplary embodiments, this can be done, for example, by ascertaining, as already described above, the process of the plurality of processes whose process cycle time cannot be reduced, and by influencing, for example increasing, the process duration of the at least one other process of the plurality of processes. In further exemplary embodiments, the increase of the process duration of the at least one other process can be carried out, for example, in such a way that its process duration is increased to a maximum (for example taking into account manufacturing constraints of the process), which in further exemplary embodiments makes it possible, for example, to increase the cycle times of, for example, the controller associated with the at least one other process or of the corresponding control loop. As a result, in further exemplary embodiments, for example, an overall load acting on the wireless communication link can be reduced.

In further exemplary embodiments of the present invention, increasing a process duration of the at least one further process may be used, for example, to increase the cycle time(s) of the controller(s) associated with the relevant process, which in further exemplary embodiments results in at least one of the following advantages, for example, with regard to the production line and/or the wireless communication link used thereby:
a) less stringent requirements, for example with regard to an end-to-end latency, for example according to 3GPP TS 22.104,
b) less stringent requirements, for example with regard to an end-to-end transmission duration, for example according to 3GPP TS 22.104,
c) lower utilization of radio resources,
d) less stringent requirements, for example for a receive power of a reference signal, for example reference signal receive power, RSRP,
e) if individual processes have less stringent requirements regarding the wireless communication link or the corresponding communication system, more communication links can be supported so that, for example, a number of wirelessly controllable machines or manufacturing cells can be increased, which can further increase the flexibility and/or throughput of manufacturing, for example without additional network or other communication resources being provided.

In further exemplary embodiments of the present invention, a process duration of the at least one further process can be increased automatically, for example without human interaction.

In further exemplary embodiments of the present invention, a process duration of the at least one further process can be increased with human interaction, for example in cases where increasing the process duration of the at least one further process would result in a violation of a boundary condition applicable to that further process.

Further exemplary embodiments of the present invention relate to a device for carrying out the method according to the embodiments.

Further exemplary embodiments of the present invention relate to a communication system having at least one device according to the embodiments. In further exemplary embodiments, for example, at least one device according to the embodiments can be provided in at least one component of the communication system, for example in an access point and/or an edge server or the like.

Further exemplary embodiments of the present invention relate to a controller, for example for distributed open- and/or closed-loop control applications, with at least one device according to the embodiments.

Further exemplary embodiments of the present invention relate to a computer-readable storage medium comprising commands that, when executed by a computer, cause said computer to perform the method according to the embodiments.

Further preferred embodiments of the present invention relate to a computer program comprising commands that, when the program is executed by a computer, cause said computer to perform the method according to the embodiments.

Further exemplary embodiments of the present invention relate to a data carrier signal that transmits and/or characterizes the computer program according to the embodiments.

Further exemplary embodiments of the present invention relate to a use of the method according to the embodiments and/or of the device according to the embodiments and/or of the communication system according to the embodiments and/or of the controller according to the embodiments and/or of the computer-readable storage medium according to the embodiments and/or of the computer program according to the embodiments and/or of the data carrier signal according to the embodiments for at least one of the following elements: a) making possible a, for example, reliable wireless communication for distributed open- and/or closed-loop control applications; b) improving a reliability and/or availability of manufacturing processes; c) optimizing a utilization of a communication system for distributed open- and/or closed-loop control applications; influencing, for example increasing, a process duration of at least one process of a plurality of processes associated with a manufacturing device.

Further features, possible applications and advantages of the present invention will be apparent from the following description of exemplary embodiments of the present invention shown in the figures. In this case, all of the features described or shown form the subject matter of the present invention individually or in any combination, irrespective of their wording or representation in the description or in the figures.

### BRIEF DESCRIPTION OF THE DRAWINGS

FIG. 1 schematically shows a simplified flowchart according to exemplary embodiments of the present invention.

FIG. 2 schematically shows a simplified flowchart according to further exemplary embodiments of the present invention.

FIG. 3 schematically shows a simplified block diagram according to further exemplary embodiments of the present invention.

FIG. 4 schematically shows a simplified block diagram according to further exemplary embodiments of the present invention.

FIG. 5 schematically shows a simplified block diagram according to further exemplary embodiments of the present invention.

FIG. 6 schematically shows a simplified flowchart according to further exemplary embodiments of the present invention.

FIG. 7 schematically shows a simplified block diagram according to further exemplary embodiments of the present invention.

FIG. 8 schematically shows a simplified block diagram according to further exemplary embodiments of the present invention.

FIG. 9 schematically shows aspects of uses according to further exemplary embodiments of the present invention.

FIG. 10 schematically shows a simplified block diagram according to further exemplary embodiments of the present invention.

FIG. 11 schematically shows a simplified flowchart according to further exemplary embodiments of the present invention.

FIG. 12 schematically shows a simplified flowchart according to further exemplary embodiments of the present invention.

FIG. 13 schematically shows a simplified block diagram according to further exemplary embodiments of the present invention.

### DETAILED DESCRIPTION OF EXAMPLE EMBODIMENTS

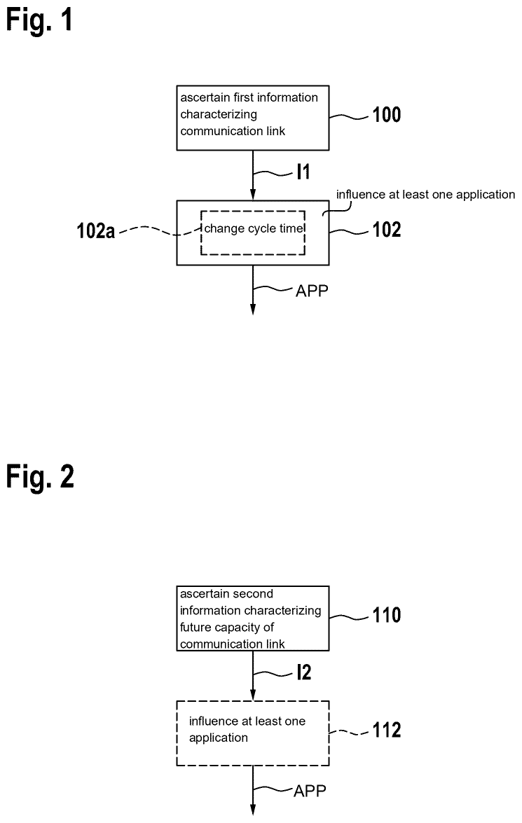

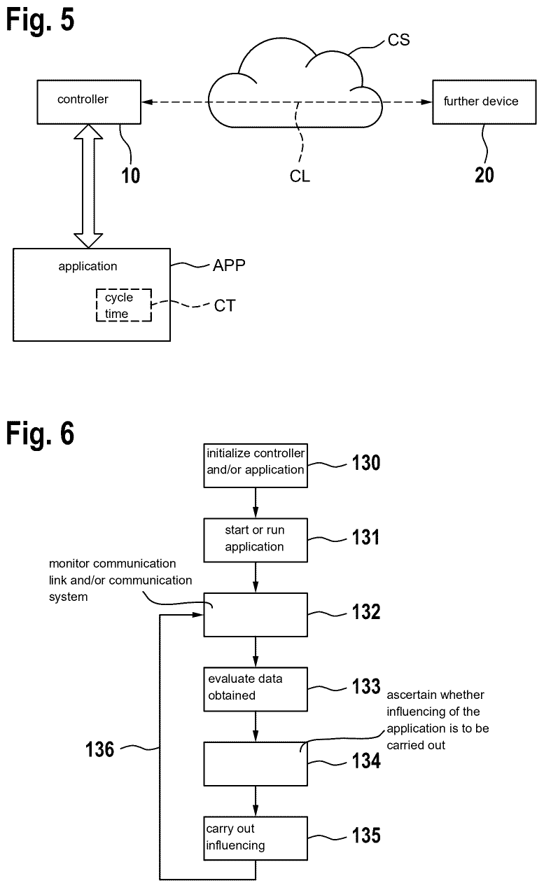

Exemplary embodiments, cf. FIGS. 1 and 5, relate to a method for processing data associated with at least one controller 10, comprising: ascertaining 100 (FIG. 1) first information I1 characterizing a communication link CL (FIG. 5), for example a capacity of a or the communication link CL, between the at least one controller 10 and at least one further device 20; influencing 102 (FIG. 1) at least one application APP executed by means of the at least one controller 10 on the basis of the first information I1. According to further exemplary embodiments, this makes possible a flexible adaptation of the operation of the application APP, for example to the (for example, current) capacity of the communication link CL.

In further exemplary embodiments, the at least one controller 10 is designed to execute distributed open- and/or closed-loop control applications, in which the at least one controller 10 is arranged remotely from the at least one further device 20, for example, and exchanges data with the at least one further device 20 via the communication link CL.

In further exemplary embodiments, the at least one further device 20 is a sensor device and/or an actuator device.

In further exemplary embodiments, the controller 10 can, for example, control at least one actuator, for example on the basis of data from at least one sensor device. In further exemplary embodiments, a closed-loop control circuit can be provided, for example, wherein data of the control loop can be transmitted at least partially via the communication link CL.

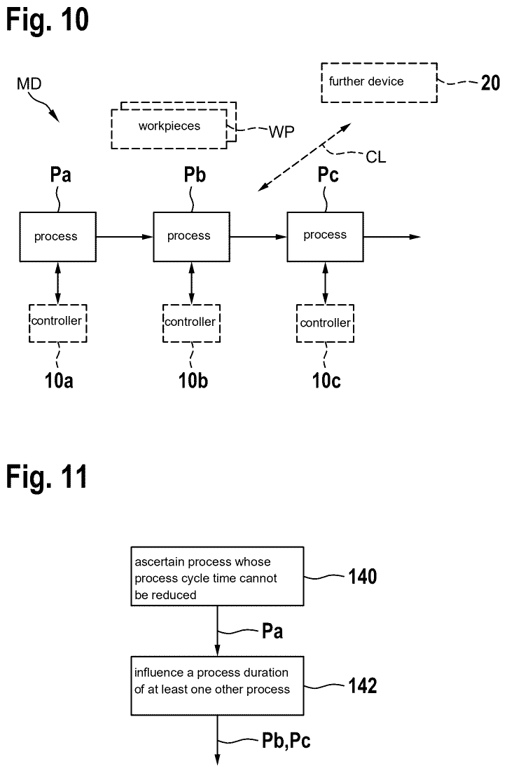

For example, in further exemplary embodiments, see FIG. 10, a plurality of controllers 10a, 10b, 10c, for example three in the present case, can be provided, which, for example, form a manufacturing device MD, for example a manufacturing system, or a part of a manufacturing device MD, for example of a manufacturing system. For example, each of the controllers 10a, 10b, 10c is associated with a relevant process Pa, Pb, Pc, which may, for example, relate to one or more aspects of a manufacturing process.

In further exemplary embodiments, FIG. 5, the communication link CL has, for example, a wireless data link at least in some areas, for example using a radio technology, for example based on a wireless communication system CS, for example according to the 4G or 5G or another standard.

In further exemplary embodiments, combinations of at least one wireless data connection and at least one wired data connection are also possible for the communication link CL.

In further exemplary embodiments, FIG. 2, the method further comprises: ascertaining 110 second information I2 characterizing a future capacity of the communication link CL between the controller 10 and the at least one further device 20, wherein the ascertainment 110 is performed, for example, on the basis of the first information I1.

The optional block 112 according to FIG. 2 symbolizes influencing at least one application APP executed by means of the controller 10 on the basis of the second information I2.

In further exemplary embodiments, the influencing 102, 112 of the at least one application APP executed by means of the controller 10 is carried out at least temporarily on the basis of the first information I1 and/or on the basis of the second information I2.

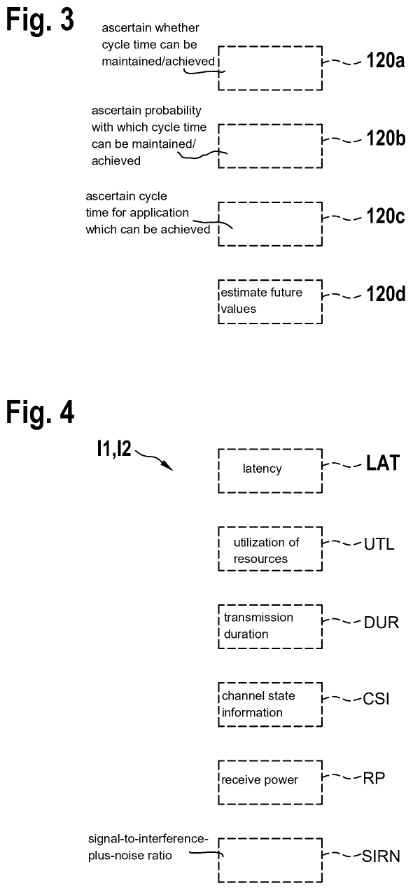

In further exemplary embodiments, FIG. 3, the method comprises at least one of the following elements: a) ascertaining 120a whether a cycle time CT (FIG. 5), for example a current cycle time and/or a prespecifiable target cycle time, of the application APP can be maintained and/or can be achieved using the communication link CL and/or a communication system CS providing the communication link CL; b) ascertaining 120b (FIG. 3) a probability with which a cycle time CT, for example a current cycle time and/or a prespecifiable target cycle time, of the application APP can be maintained and/or can be achieved; c) ascertaining 120c a cycle time for the application APP, which can be achieved, for example with a prespecifiable probability; d) estimating 120d future values relating to at least one of the above aspects a), b), c).

In further exemplary embodiments, the cycle time CT may, for example, characterize a time between two successive messages of the same type, which, for example, the controller 10 exchanges with the at least one further device 20, for example a sensor device and/or an actuator device.

In further exemplary embodiments, FIG. 4, the first information I1 and/or the second information 12 comprise at least one of the following elements: a) a latency LAT, for example end-to-end latency, for example according to 3GPP (3rd Generation Partnership Project) TS (technical specification) 22.104; b) a utilization UTL of the resources, for example radio resources, of a base station associated with the communication link and/or of a radio cell and/or of another component of a communication system; c) a transmission duration DUR, for example according to 3GPP TS 22.104; d) channel state information CSI, for example of a radio channel associated with the communication link, for example channel state information, CSI; e) a receive power RP of a reference signal, for example reference signal receive power, RSRP; f) signal-to-interference-plus-noise ratio SINR.

In further exemplary embodiments, the influencing 102, 112 (FIGS. 1 and 2) comprises changing 102a a or the cycle time CT of the application APP, wherein, for example, the changing 102a is performed on the basis of a prespecifiable precision and/or duration of a process associated with the application APP, for example a closed-loop control process.

In further exemplary embodiments, FIG. 6, the method comprises at least one of the following elements: a) initializing 130, for example, the at least one controller 10, 10a, 10b, 10c and/or the application APP; b) starting 131 or running the application APP; c) monitoring 132 the communication link CL and/or a or the communication system CS, wherein, for example, the first information I1 and/or the second information 12 are obtained during the monitoring 132; d) evaluating 133 data obtained, for example, during the monitoring 132; e) ascertaining 134, for example, on the basis of the evaluation 133, whether the influencing 135, 102, 112 of the application APP is to be carried out; f) optionally carrying out the influencing 135 of the application APP.

In further exemplary embodiments, the initialization 130 comprises, for example, at least one of the following elements: a) setting target values, for example for the application APP or a controller that executes the application APP; b) specifying requirements and/or constraints; c) configuring, for example, the communication link CL or at least one component of a communication system CS associated with the communication link CL.

In further exemplary embodiments, starting 131 the application APP comprises: starting the application with initial parameter values, for example based on the initialization.

In further exemplary embodiments, the monitoring 132 of the communication link CL and/or the communication system CS comprises, for example, at least one of the following elements: a) repeated, for example regular, monitoring of the communication link and/or the communication system; b) at least temporary storage of information relating to the monitoring, for example of the first information I1.

In further exemplary embodiments, evaluating 133 the data, for example obtained during the monitoring 132, comprises at least one of the following elements: a) evaluating the data, for example according to prespecifiable criteria; b) ascertaining, for example estimating, future values with regard to the data, for example future trends, wherein, for example, the second information I2 is obtained.

In further exemplary embodiments, ascertaining 134 whether the influencing of the application is to be carried out comprises: a) comparing current values, for example values associated with the application, for example values of the control system, with estimated values relating to the communication link or the communication system; b) ascertaining whether values of the control system are to be changed or influenced.

In further exemplary embodiments, the method comprises: repeating 136 at least one of the following elements: c) monitoring 132 the communication link CL and/or a or the communication system CS, wherein in the monitoring, for example, the first information I1 and/or the second information 12 are obtained; d) evaluating 133 data obtained, for example, during the monitoring; e) ascertaining 134, for example, on the basis of the evaluation, whether the influencing of the application is to be carried out; f) optionally carrying out 135 the influencing of the application.

In further exemplary embodiments, the exemplary sequence according to FIG. 6 provides for a, for example, continuous monitoring and ascertaining of the first information I1 and the second information 12, for example for estimating future trends, on the basis of which the influencing 135 can be carried out if applicable.

In further exemplary embodiments, it can be ascertained, for example, whether or to what extent the estimated future capacity of the communication system CS or of the communication link CL corresponds to prespecifiable requirements, for example to a required cycle time and/or corresponding buffer times therefor and/or to a required process precision and/or duration. In further exemplary embodiments, a decision can be made on the basis of such an ascertainment, cf. block 134, as to whether and to what extent the application or an associated process, for example production process, is configured or influenced. A corresponding adjustment or influence can then be performed on the basis of the decision 134 (see block 135).

In further exemplary embodiments, machine learning (ML) and/or artificial intelligence (AI) methods or algorithms may be used, for example to ascertain the second information 12, for example on the basis of the first information I1, for example in order to extrapolate performance indicators.

In further exemplary embodiments, for example using ML and/or AI methods, for example time-variant probability density functions of one or more, for example of all, performance indicators which are, for example, important for the application APP can be ascertained, which indicate, for example, how great is the probability of a particular performance indicator or particular performance indicators falling below a corresponding limit value in the future. In further exemplary embodiments, for example, context information of the, for example industrial, application APP can also be used, for example in order to improve an information base for the aforementioned exemplary extrapolations, whereby a precision of the predictions can be increased.

In further exemplary embodiments, FIGS. 10 and 11, a plurality of processes Pa, Pb, Pc are associated with a or the manufacturing device MD, wherein, for example, the plurality of processes Pa, Pb, Pc can be executed sequentially, for example by respective controllers 10a, 10b, 10c, wherein the method comprises: ascertaining 140 a process Pa of the plurality of processes Pa, Pb, Pc whose process cycle time cannot be reduced (for example without violating a requirement regarding a precision); influencing 142, for example increasing, a process duration of at least one other process Pb, Pc of the plurality of processes Pa, Pb, Pc.

In further exemplary embodiments, influencing 142, for example increasing, the process duration of the at least one other process Pb, Pc of the plurality of processes is carried out taking into account at least one of the following aspects: a) the process cycle time is not extended and/or does not exceed a prespecifiable threshold value (thereby ensuring, for example, that increasing a process cycle time does not have any negative influence on manufacturing throughput); b) individual process durations do not exceed a maximum process cycle time; c) an individual process duration of the at least one other process Pc, Pb of the plurality of processes corresponds to at least one prespecification for the at least one other process (for example, in order to take into account process-specific boundary conditions, for example relating to process duration and/or speed and/or precision).

In further exemplary embodiments, FIG. 10, the manufacturing device MD, for example production line or manufacturing line, can comprise a number of machines and/or manufacturing cells by means of which, for example, various manufacturing processes Pa, Pb, Pc can be applied to workpieces WP. In further exemplary embodiments, the manufacturing processes Pa, Pb, Pc may comprise at least one of the following elements: assembly, soldering, gluing, etc.

In further exemplary embodiments, workpieces WP generally pass through the production line MD in a prespecifiable sequence of processes Pa, Pb, Pc, for example manufacturing processes, and with an identical process cycle time, which is to be distinguished, for example, from a cycle time of, for example, a controller or a control loop that can be realized, for example, by means of the controller. In further exemplary embodiments, the cycle time of, for example, the controller or of the control loop lies, for example, within the range of a few milliseconds while the process cycle time lies, for example, within the range of seconds. For example, the cycle time, for example of the controller or of the control loop, characterizes a compromise or trade-off between a process duration and a precision of the process, whereas the process cycle time indicates for how long a process or the relevant process is applied to a workpiece.

In further exemplary embodiments, transfers of a workpiece WP from one process Pa to another process Pb are carried out, for example for all workpieces WP, in substantially the same time, i.e. independently of the relevant process. However, in further exemplary embodiments, the actual process time spent may vary among different processes Pa, Pb, Pc of a production line MD, wherein, for example, one of the different processes of the production line, for example the process Pa with the longest process cycle time, may be regarded as a bottleneck for the total production time (for example, sum of the respective process durations plus, if applicable, the time required for transferring the workpieces between the processes).

In further exemplary embodiments, for example, production engineers can ascertain the longest process cycle time or the (bottleneck) process Pa with the longest process cycle time and, for example, reduce the longest process cycle time, for example in order to maximize production throughput (for example characterizable by a number of workpieces, for example products, produced per unit of time).

In further exemplary embodiments, in which, for example, at least one wireless communication link CL, for example based on a 5G infrastructure, is used for communication between different processes (and/or the further unit 20), wherein, for example, the different processes Pa, Pb, Pc use the same (shared) transmission medium (for example, air or radio interface) it may be advantageous, according to further exemplary embodiments, to jointly configure or influence the processes, for example also the communication processes via the wireless communication link CL, of a manufacturing device MD comprising several processes Pa, Pb, Pc or controllers 10a, 10b, 10c, for example a production line. In further exemplary embodiments, this can be done, for example, by ascertaining 140 (FIG. 11), as already described above, the process Pa of the plurality of processes whose process cycle time cannot be reduced, and by influencing, for example increasing, 142 the process duration of the at least one other process Pb, Pc of the plurality of processes. In further exemplary embodiments, increasing 142 the process duration of the at least one other process Pb, Pc can, for example, be carried out in such a way that its process duration is increased to a maximum (for example, taking into account manufacturing boundary conditions of the process), which in further exemplary embodiments makes it possible, for example, to increase the cycle times of, for example, the controller(s) 10b, 10c associated with the at least one other process Pb, Pc or of the corresponding control loop. As a result, in further exemplary embodiments, for example, an overall load acting on the wireless communication link CL can be reduced.

In further exemplary embodiments, increasing 142 a process duration of the at least one further process Pb, Pc may, for example, be used to increase the cycle time(s) of the controller(s) 10b, 10c associated with the relevant process, which in further exemplary embodiments brings about at least one of the following advantages, for example relating to the production line and/or the wireless communication link used thereby:
a) less stringent requirements, for example with regard to an end-to-end latency, for example according to 3GPP TS 22.104,
b) less stringent requirements, for example with regard to an end-to-end transmission duration, for example according to 3GPP TS 22.104,
c) lower utilization of radio resources,
d) less stringent requirements, for example for a receive power of a reference signal, for example reference signal receive power, RSRP,
e) if individual processes have less stringent requirements for the wireless communication link CL or the corresponding communication system, more communication links can be supported, so that, for example, a number of wirelessly controllable machines or manufacturing cells can be increased, which can further increase the flexibility and/or throughput of manufacturing, for example without additional network or other communication resources being provided.

In further exemplary embodiments, increasing 142 a process duration of the at least one further process Pb, Pc can be carried out automatically, for example without human interaction.

In further exemplary embodiments, increasing 142 a process duration of the at least one further process Pb, Pc can be carried out with human interaction, for example in cases where increasing the process duration of the at least one further process would mean a violation of a boundary condition applicable to this further process.

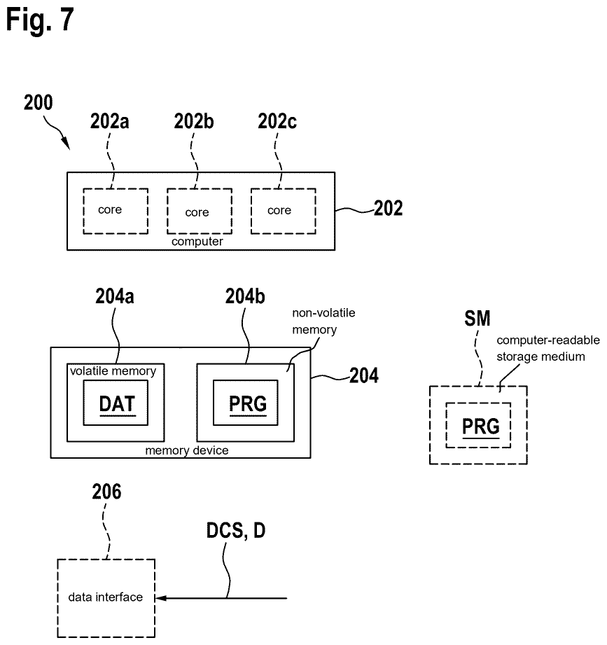

Further exemplary embodiments, FIG. 7, relate to a device 200 for carrying out the method according to the embodiments.

The device 200 comprises a computing device 202 (“computer”) comprising at least one computing core 202a, 202b, 202c and comprises a memory device 204 assigned to the computing device 202 for the at least temporary storage of data DAT and/or computer programs PRG. The memory device 204 can, for example, comprise a volatile memory 204a (for example, working memory, RAM) and/or a non-volatile memory 204b (for example flash EEPROM).

In further preferred embodiments, the device 200 comprises a, preferably bidirectional, data interface 206, for example for data communication with at least one component of the communication system CS (FIG. 5) and/or at least one of the components 10, 20, for example for exchanging data D associated with the controller 10.

Further exemplary embodiments, FIG. 5, relate to a communication system CS with at least one device 200 (FIG. 7) according to the embodiments. In further exemplary embodiments, for example, at least one device 200 according to the embodiments may be provided in at least one component of the communication system CS, for example in an access point, and/or an edge server or the like.

Further exemplary embodiments relate to a controller 10 (FIG. 5), for example for distributed open- and/or closed-loop control applications, with at least one device 200 according to the embodiments.

Further exemplary embodiments relate to a computer-readable storage medium SM (FIG. 5), comprising commands PRG that, when executed by a computer 202, cause said computer to carry out the method according to the embodiments.

Further preferred embodiments relate to a computer program PRG comprising commands that, when the program PRG is executed by a computer 202, cause said computer to carry out the method according to the embodiments.

Further exemplary embodiments relate to a data carrier signal DCS that transmits and/or characterizes the computer program PRG according to the embodiments.

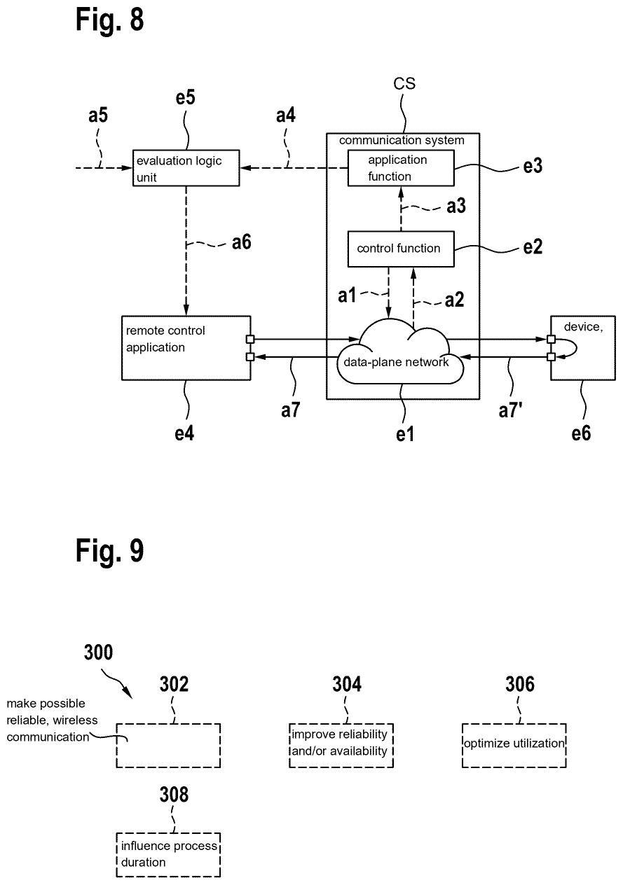

FIG. 8 schematically shows a simplified block diagram according to further exemplary embodiments. A communication system CS is shown that comprises a data-plane network e1 that transmits, for example, control and/or feedback information between a remote control application e4 (for example, similar to the application APP according to FIG. 5) and comprises a device e6, for example a machine or an actuator, cf. the arrows a7, a7′, and a control function e2 configuring and/or influencing and/or optimizing data streams associated with the communication link a7, a7′, cf. the arrows a1 (for example, configuration data), a2 (for example, monitoring data).

When a 5G-based communication system CS is used, the data-plane network e1 may be characterized, for example, by the user plane function (UPF), and the control function e2 is a 5G control plane, which can have, for example, a plurality of different functions, such as a session management function (SMF).

In further exemplary embodiments, information about the communication system CS, for example also the first information I1, for example measurements of latency times LAT, may be obtained from a function of the 5G control plane.

In further exemplary embodiments, information a3 about the communication system CS, for example also the first information I1, for example measurements of latency times LAT, may also be provided, for example by means of a 5G service exposure functionality, for example for an application function e3. The information a3 can, for example, comprise historical performance data I1).

In further exemplary embodiments, the application function e3 can be used, for example, to ascertain or estimate future values a4 relating to the first information I1, for example also to ascertain the second information 12, for example in the form of one or more performance indicators, for example KPIs (key performance indicators), for example end-to-end latency.

In further exemplary embodiments, an evaluation device, for example evaluation logic unit, e5 is provided which evaluates, for example, the second information I2, a4 and requirements and/or constraints a5 relating to the application e4. In further exemplary embodiments, the requirements and/or constraints a5 may, for example, be prespecified by a person who, for example, supervises or plans a production associated with the application e4.

In further exemplary embodiments, the evaluation logic unit e5 is designed to collect the second information I2, a4 and the requirements and/or constraints a5 and, for example, to adjust at least one parameter of the application e4, for example the cycle time CT, on the basis of this information or data I2, a4, a5, cf. the arrow a6. The evaluation logic unit e5 can, for example, also take into account the requirements and/or constraints a5, for example relating to an accuracy or precision of the application e4 and/or a duration.

In further exemplary embodiments, the evaluation logic unit e5 is designed to adjust one of a plurality of parameters relating to the application e4 and to keep the other parameters of the plurality of parameters constant.

In further exemplary embodiments, the evaluation logic unit e5 is designed to provide an optimization of a plurality of parameters, for example on the basis of a prespecifiable metric which characterizes, for example, a degree of optimization, wherein at least some of the plurality of parameters can have, for example, prespecifiable permissible maximum values and/or minimum values.

In further exemplary embodiments, one or more of the following aspects may be provided, for example in connection with block 134 according to FIG. 6 and/or with the exemplary configuration according to FIG. 8.

In further exemplary embodiments, the cycle time T_C of an application APP and an end-to-end latency T_L of the communication link CL or of the communication system CS are connected according to the following relation:

$$T\_C > ( T\_L + T\_HCL ) + T\_P + T\_A ,$$

where T_HCL characterizes a (processing) time for higher communication layers, where T_P characterizes a (processing) time for executing the (control) application APP (for example by the controller 10, which may be provided in a cloud system, for example), and where T_A characterizes a (processing) time of the application relating to the at least one further device 20 (for example, actuators, sensors), which time may be constant in further exemplary embodiments, for example.

In further exemplary embodiments, for example, the following sequence is possible: based on block 133 according to FIG. 6, for example, an estimate for the (time-variant) probability density function (PDF) of the end-to-end latency T_L, which can, for example, be denoted by p (T_L, t), may be known, where t characterizes time.

In further exemplary embodiments, for example a probability P_1 (T_L′, t′) of the end-to-end latency T_L exceeding a threshold value T_L′ up until time t′ can be ascertained on the basis of this probability density function.

In further exemplary embodiments, for example a probability P_2 (T_L′, t″) of the end-to-end latency T_L exceeding a threshold value T_L″ up until time t″ or later can be ascertained.

In further exemplary embodiments, it is possible to ascertain, for example, on the basis of the probabilities P_1, P_2 and possibly also on the basis of limit values with regard to these probabilities (“forward” and/or “backward” probabilities) and possibly on the basis of the aforementioned relation, whether, for example, the cycle time CT, T_C is to be influenced, for example changed, for example shortened or extended. This means that in other exemplary embodiments, a current or future capacity of the communication link CL can be taken into account.

In further exemplary embodiments, a new target value for the cycle time CT, T_C can be ascertained, for example, also on the basis of the PDF p (T_L, t), wherein, for example, boundary conditions, for example boundary conditions specific to the application APP, can be taken into account, such as an effect of a change in the cycle time CT, T_C on a manufacturing process and/or a manufacturing duration associated with the application (for example, in cases in which the application characterizes a closed-loop control process of a manufacturing device).

For example, in further exemplary embodiments, in cases in which the cycle time CT, T_C is increased, it can be checked whether a new target value for the cycle time would lead to a process precision that lies above a prespecifiable minimum value and/or to a process duration that lies above a prespecifiable maximum value, wherein in further exemplary embodiments this minimum value and/or maximum value can also be dynamic, i.e. variable over time, for example. For example, in further exemplary embodiments, a relationship between the cycle time, the process precision and the process duration can be characterized by physical and/or mechanical specifications of the process.

In further exemplary embodiments, one or more of the following aspects can be provided, for example in connection with block 135 according to FIG. 6.

In further exemplary embodiments, for example, an application APP designed as a closed-loop control system is designed adaptively so that it can be adjusted dynamically, i.e. during runtime or its execution, for example by the controller 10, for example with regard to a change in parameters such as cycle time, etc.

Advantageously, in further exemplary embodiments, the various components 10, 20 involved in the application APP can in each case be properly configurable, for example for influencing the application APP, such as adjusting the cycle time. In further exemplary embodiments, at least one dedicated control channel or logic channel a6 (FIG. 8) can, for example, be provided for this purpose between the components e4, e5 and/or between the components e5, e6.

In further exemplary embodiments, information, for example about a new target value for the cycle time CT, can also be transmitted, for example as part of a control message, from the block e4 to the block e6, for example using a corresponding protocol.

In further exemplary embodiments, one or more of the following aspects may be provided:
1) A hysteresis, for example relating to a decision to change the cycle time CT. In further exemplary embodiments, the hysteresis can be provided, for example, within the framework of the threshold values for a “forward” and/or “backward” probability, for example by providing a sufficiently large distance between the two threshold values. The hysteresis can, for example, help to prevent a continuous change in the cycle time, which could cause an undesirable communication or other overhead or even impair the stability of the APP application, for example a closed-loop control system.
2) In further exemplary embodiments, for example in complex systems or applications APP, a relation between the cycle time and the process precision and/or the process duration can be analyzed and/or learned, for example by means of automatable measurement procedures and/or on the basis of ML and/or AI methods.

Further exemplary embodiments, FIG. 9, relate to a use 300 of the method according to the embodiments and/or of the device 200 according to the embodiments and/or of the communication system CS according to the embodiments and/or of the controller 10 according to the embodiments and/or of the computer-readable storage medium SM according to the embodiments and/or of the computer program PRG according to the embodiments and/or of the data carrier signal DCS according to the embodiments for at least one of the following elements: a) making possible 302, for example a reliable, wireless communication for distributed open- and/or closed-loop control applications; b) improving 304 a reliability and/or availability of manufacturing processes; c) optimizing 306 a utilization of a communication system CS for distributed open- and/or closed-loop control applications APP; influencing, for example increasing, 308 a process duration of at least one process Pb, Pc of a plurality of processes Pa, Pb, Pc associated with a manufacturing device.

In further exemplary embodiments, FIG. 8, the evaluation device e5 is designed to supply decisions and/or recommendations, for example for personnel of the manufacturing device MD (FIG. 10) or to send them to the personnel of the manufacturing device MD, thereby making human interaction possible, for example in some exemplary embodiments.

For example, in further exemplary embodiments, the evaluation device e5 can, for example as soon as it has ascertained new control parameters, for example parameters for the application e4, for example the cycle time CT or a process cycle time of a process Pb (FIG. 10), communicate the new control parameters, for example to a person, wherein the person can, for example, confirm (for example, select for application) and/or reject or discard the new control parameters, and/or take note of them, for example without intervening in the control by the evaluation device e5.

In further exemplary embodiments, the production line may comprise one or more closed-loop control applications and/or one or more machines or manufacturing cells associated with, for example, at least one of the plurality of, for example sequential, processes Pa, Pb, Pc.

In further exemplary embodiments, the principle according to the embodiments can be applied to several production lines MD, which, for example, have a common manufacturing process as their object.

In further exemplary embodiments, the communication system CS (FIG. 8) is used by various manufacturing cells or machines or other devices, which can be divided into modules, for example.

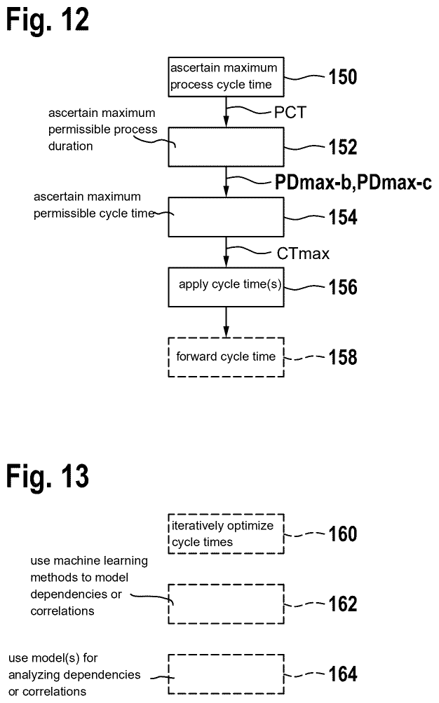

In further exemplary embodiments, cf. FIGS. 12 and 13, one or more of the aspects, described by way of example below, of possible strategies 1 and/or 2 may be used at least temporarily, for example in order to reduce a resource requirement of the communication system CS and/or to make possible further communication connections, for example with the same resources.

### Strategy 1:

a) ascertaining 150 (FIG. 12) a maximum process cycle time (process duration of the bottleneck process Pa, for example, of a production line MD) PCT, for example using available measuring devices or tools,
b) ascertaining 152 a maximum permissible process duration PDmax-b, PDmax-c of processes Pb, Pc other than the bottleneck process Pa,
c) for example for at least one process step, for example for some process steps, for example for all process steps, ascertaining 154 a maximum permissible cycle time CTmax of an associated controller 10b (FIG. 10) or of a corresponding control loop, for example on the basis of the maximum permissible process duration PDmax-b and/or on the basis of specifications and/or boundary conditions (for example precision) of the process,
d) applying 156 the cycle time or cycle times for the controller or controllers or their control loops, for example when the corresponding boundary conditions can be fulfilled, and/or when the communication system CS (FIG. 8) can guarantee or implement, for example, at least one of the following aspects: d1) minimum end-to-end latency, for example for a newly ascertained cycle time for a controller or an associated control loop; d2) a, for example aggregated or combined, utilization of radio resources (for example, time and/or frequency resources) falls below a prespecifiable threshold value. In further exemplary embodiments, in particular aspect d2) can characterize an important requirement since changed cycle times for the controller or a closed-loop controller may increase a utilization of radio resources in the short term, for example if several data are to be sent synchronously, although in further exemplary embodiments it is assumed that the utilization of radio resources is reduced.

### Strategy 2:

For example, if the boundary conditions cannot be met, nevertheless applying 156 the cycle time or cycle times which would possibly increase a maximum process cycle duration (in which case, for example, a buffer can be prespecified), or, for example alternatively, forwarding 158 the cycle time, for example to an operator, for example of the manufacturing device MD, for example for a manual confirmation of the cycle time(s) by the operator.

In further exemplary embodiments, a resource utilization of the communication system CS (FIG. 8) may be correlated by different process steps or processes, wherein a throughput of a relevant manufacturing device MD can possibly be limited by a process or process step that is not, for example, ideally supported by the communication system CS. In further exemplary embodiments, the application of the principle according to the embodiments can possibly help to improve the resource situation for the process that is not ideally supported by the communication system CS, for example to now provide all the required resources.

In further exemplary embodiments, dependencies can be taken into account, for example relating to a utilization of resources of the communication system CS by different processes or process steps, and, for example, cycle times for the respective processes can be adjusted accordingly, for example in order to achieve a compromise for the distribution of resources.

In further exemplary embodiments, FIG. 13, at least one of the aspects described below by way of example can be used, for example to achieve a compromise for the distribution of resources.
Aspect 1): Iteratively optimizing 160 cycle times for a controller or control loop(s) associated therewith in respective process steps,
Aspect 2): Using 162 machine learning (ML) methods, for example to model the dependencies or correlations mentioned,
Aspect 3): Using 164 a model for the manufacturing device MD (FIG. 10) and the communication system CS (FIG. 8), for example for analyzing the dependencies or correlations mentioned.

In further exemplary embodiments, it is also possible to combine a plurality of the aspects 1, 2, 3 described above by way of example, cf. blocks 160, 162, 164.

In further exemplary embodiments, for example a process step or a plurality of process steps, for example all process steps, can each be assigned a “dedicated” evaluation device or evaluation logic unit, wherein the plurality of evaluation devices are controlled, for example, by a, for example central, orchestration and/or arbitration function or a corresponding protocol, wherein, for example, a balance, for example relating to a resource utilization of the communication system CS, can be achieved or maintained in a distributed manner.

In further exemplary embodiments, the functions described above by way of example can be executed, for example not continuously but, for example, on an event-driven basis, whereby, for example, a repeated reconfiguration and thus a possibly associated consumption of computing time resources and/or energy can be avoided. In further exemplary embodiments, event control can be performed manually, for example, by an operator of a manufacturing device MD, or, for example, on the basis of an event that characterizes a high resource utilization.

1-17. (canceled)

18. A method for processing data associated with at least one controller of a manufacturing device, comprising the following steps:
ascertaining first information characterizing a communication link including a capacity of the communication link between the at least one controller and at least one further device; and
influencing at least one application executed by the at least one controller based on the first information.

19. The method according to claim 18, further comprising the following:
ascertaining second information characterizing a future capacity of the communication link between the at least one controller and the at least one further device, wherein the ascertainment is performed based on the first information.

20. The method according to claim 18, wherein the influencing of the at least one application executed by the at least one controller is carried out at least temporarily based on the first information and/or on the second information.

21. The method according to claim 18, further comprising at least one of the following elements: a) ascertaining whether a cycle time of the application can be maintained and/or can be achieved using the communication link and/or a communication system providing the communication link; b) ascertaining a probability with which a cycle time of the application can be maintained and/or can be achieved; c) ascertaining a cycle time for the application which can be achieved with a prespecifiable probability; d) estimating future values relating to at least one of a), b), c).

22. The method according to claim 18, wherein the first information and/or the second information include at least one of the following elements: a) a latency; b) a utilization of resources associated with the communication link; c) a transmission duration; d) channel state information associated with the communication link; e) a receive power of a reference signal; f) signal-to-interference-plus-noise ratio.

23. The method according to claim 18, wherein the influencing includes changing a cycle time of the application, wherein the changing is performed based on a prespecifiable precision and/or duration of a process associated with the application.

24. The method according to claim 18, comprising at least one of the following elements: a) initializing the at least one controller and/or the application; b) starting or executing the application; c) monitoring the communication link and/or a communication system, wherein the first information is obtained during the monitoring; d) evaluating data obtained during the monitoring; e) ascertaining based on the evaluation, whether the influencing of the application is to be carried out; f) carrying out the influencing of the application.

25. The method according to claim 24, further comprising: repeating at least one of the following elements: c) monitoring the communication link and/or a communication system, wherein the first information is obtained during the monitoring; d) evaluating data obtained during the monitoring; e) ascertaining, based on the evaluation, whether the influencing of the application is to be carried out; f) carrying out the influencing of the application.

26. The method according to claim 18, wherein a plurality of processes are associated with the manufacturing device, wherein the plurality of processes can be executed sequentially, wherein the method further comprises: ascertaining a process of the plurality of processes whose process cycle time cannot be reduced; and influencing a process duration of at least one other process of the plurality of processes.

27. The method according to claim 26, wherein the influencing of the process duration of the at least one other process of the plurality of processes is carried out taking into account at least one of the following aspects: a) a process cycle time is not extended and/or does not exceed a prespecifiable threshold value; b) individual process durations do not exceed a maximum process cycle time; c) an individual process duration of the at least one other process of the plurality of processes corresponds to at least one prespecification for the at least one other process.

28. A device configured to process data associated with at least one controller of a manufacturing device, the device configured to:
ascertain first information characterizing a communication link including a capacity of the communication link between the at least one controller and at least one further device; and
influence at least one application executed by the at least one controller based on the first information.

29. A non-transitory computer-readable storage medium on which is stored a computer program including commands for processing data associated with at least one controller of a manufacturing device, the commands, when executed by a computer, causing the computer to perform the following steps:
ascertaining first information characterizing a communication link including a capacity of the communication link between the at least one controller and at least one further device; and
influencing at least one application executed by the at least one controller based on the first information.

30. The method according to claim 18, wherein the method is used for at least one of the following elements: a) making possible a reliable wireless communication for distributed open- and/or closed-loop control applications; b) improving a reliability and/or availability of manufacturing processes; c) optimizing a utilization of a communication system for distributed open- and/or closed-loop control applications; d) influencing a process duration of at least one process of a plurality of processes associated with a manufacturing device.
